(19) United States
(12) Patent Application Publication
(10) Pub. No.: US 2018/0072325 A1
(43) Pub. Date: Mar. 15, 2018

(54) TRAVEL CONTROL DEVICE

(71) Applicant: HONDA MOTOR CO., LTD, Tokyo (JP)

(72) Inventor: Masaki Koike, Wako-shi (JP)

(21) Appl. No.: 15/693,715

(22) Filed: Sep. 1, 2017

(30) Foreign Application Priority Data
Sep. 9, 2016 (JP) 2016-176526

(51) Int. Cl. B60W 50/00; G05D 1/00; B60W 50/08

(52) U.S. Cl. CPC B60W 50/0098; G05D 1/0061; B60W 50/082; B60W 50/085; B60W 2720/12; B60W 2540/22; B60W 2550/12; B60W 2550/30; B60W 2720/10; G05D 2201/0213

(57) ABSTRACT

A travel control device controls automatic driving that assists driving operations of a driver, or automatic driving that enables traveling without requiring driving operations of the driver. The travel control device alleviates limitations on vehicle body behavior amounts during automatic driving, in accordance with the state of vehicle occupants detected by vehicle occupant sensors.

### CROSS-REFERENCE TO RELATED APPLICATION

This application is based upon and claims the benefit of priority from Japanese Patent Application No. 2016-176526 filed on Sep. 9, 2016, the contents of which are incorporated herein by reference.

### BACKGROUND OF THE INVENTION

### Field of the Invention

The present invention relates to a travel control device adapted to control automatic driving that assists driving operations of a driver, or automatic driving that enables traveling without requiring driving operations of the driver.

### Description of the Related Art

Japanese Laid-Open Patent Publication No. 10-029547 addresses the issue of providing a steering control device, which is capable of mechanically restricting automatic steering within a fixed steering angle range, yet without restricting manual steering (see paragraph [0007] and abstract).

In order to solve this problem, the steering control device of Japanese Laid-Open Patent Publication No. 10-029547 (see abstract, FIGS. 1 and 2) is equipped with a manual steering mechanism 1, an automatic steering mechanism 3, a clutch 41, and a stopper 42. The manual steering mechanism 1 steers front wheels 13 in accordance with a steering angle of a steering wheel 5. The automatic steering mechanism 3 automatically steers the front wheels 13 through the control of an actuator 27 in accordance with a control means 47 into which traveling environment information is input. The clutch 41 is interposed in the automatic steering mechanism 3, and only automatic steering is interrupted thereby. The stopper 42 functions when the clutch 41 is engaged, and mechanically regulates the steering angle range of the automatic steering. Consequently, during automatic steering, it is contemplated to prevent the vehicle from deviating from the lane (see paragraph [0005]), and so as not to interfere with manual steering (see paragraph [0006]).

In Japanese Laid-Open Patent Publication No. 10-029547, in the case that an absolute value of the steering wheel angle is not less than θref (step S12: NO) when a switch for initiating automatic driving is pressed (step S11 of FIG. 4(b): YES), then automatic driving is not initiated ([0078]).

### SUMMARY OF THE INVENTION

As noted above, in Japanese Laid-Open Patent Publication No. 10-029547, the steering angle range for automatic steering is mechanically restricted by the stopper 42 (see FIGS. 1 and 2). Stated otherwise, in Japanese Laid-Open Patent Publication No. 10-029547, the steering angle range at the time of automatic steering is fixed. However, when the steering angle range at the time of automatic steering is fixed in this manner, it is not possible to deal with various changes related to traveling of the vehicle.

For example, when the steering angle range is narrowed and fixed as in Japanese Laid-Open Patent Publication No. 10-029547, turning requiring a large steering angle becomes difficult to perform, which may impart a feeling of unease or discomfort to the driver. Further, in a configuration in which additional steering by the driver is enabled during automatic steering, there is a possibility that the driver cannot perform such additional steering due to the limitation on the steering angle range. In that case, since a steering angle that could actually be achieved under manual operation cannot be realized during automatic steering, there is a concern that a sense of discomfort will be imparted to the driver.

Moreover, the above problem also applies to controlling a vehicle body control amount not only by automatic steering, but also other automatic operations (for example, automatic acceleration or deceleration). Further, the automatic operations referred to herein include both of a partial automatic operation (auxiliary automatic operation) premised on a concurrent driving operation of the driver, and a complete automatic operation (in other words, in which the device functions as the driver) in which operations performed by the driver do not exist.

The present invention has been devised taking into consideration the aforementioned problems, and has the object of providing a travel control device which is capable of positively controlling traveling in a manner suitable to the sensations of a vehicle occupant.

A travel control device according to the present invention is adapted to control automatic driving to assist driving operations of a driver, or to control automatic driving to enable traveling without requiring driving operations of the driver, wherein the travel control device is configured to alleviate a limitation on a vehicle body behavior amount during the automatic driving, in accordance with a state of a vehicle occupant detected by a vehicle occupant sensor.

According to the present invention, the limitation on the vehicle body behavior amount during independent or auxiliary (complete or partial) automatic driving is alleviated in accordance with the state of the vehicle occupant. Stated otherwise, the limitation on the vehicle body behavior amount is made to change depending on the state of the vehicle occupant. Therefore, a positive travel control fitting with the sensations of the vehicle occupant is made possible.

The vehicle body behavior amount can be, for example, one or more of a steering angle, a lateral acceleration, a yaw rate, a longitudinal acceleration, a vehicle velocity, and a longitudinal deceleration of the vehicle.

The travel control device may acquire as the state of the vehicle occupant an operation amount of turning, acceleration, or deceleration by the vehicle occupant. Further, the travel control device may be configured to alleviate the limitation on the vehicle body behavior amount targeted by the operation amount in accordance with an increase in the operation amount. In accordance with this feature, it becomes possible to change the limitation on the vehicle body behavior amount depending on the intention of the vehicle occupant in relation to turning (including steering), acceleration, or deceleration. Consequently, it is possible to reduce a feeling of unease or discomfort felt by the vehicle occupant in relation to the vehicle body behavior amount.

The travel control device may be configured to switch an operation of the operation amount to manual, if the operation amount exceeds an operation amount threshold value. In accordance with this feature, in the case it is possible to determine that the driver is intending to perform an operation at the operation amount, operability can be enhanced by handing over the responsibility for the operation at the operation amount to the driver.

The travel control device may be configured to limit the vehicle body behavior amount if it is determined that the state of the vehicle occupant detected by the vehicle occupant sensor indicates that the vehicle occupant is in a tense or nervous state. In accordance with this feature, by limiting the vehicle body behavior amount when the vehicle occupant is in a tense or nervous state due to the behavior of the vehicle body, which is being driven automatically in an independent or auxiliary manner, the state of tension or nervousness of the vehicle occupant can be reduced.

The travel control device may be configured to alleviate the limitation on the vehicle body behavior amount based on a seated position of the vehicle occupant, which is detected by a seat sensor contained within the vehicle occupant sensor. In accordance with this feature, it is possible to set an appropriate vehicle body behavior amount depending on whether vehicle occupants are seated in the driver's seat, a passenger seat, and/or a rear seat.

The travel control device may be configured to reduce an amount of alleviation of the limitation on the vehicle body behavior amount, or may be configured to enhance the limitation on the vehicle body behavior amount, in a case that the vehicle occupant is seated in a seat other than a driver's seat. In accordance with this feature, in the case that vehicle occupants other than the driver are on board the vehicle, it is possible to improve riding comfort for the vehicle occupants other than the driver by carrying out traveling in a more gentle manner.

In the travel control device, in comparison with a case in which vehicle occupants are seated in both the driver's seat and the seat other than the driver's seat, in a case that the vehicle occupant is seated in the seat other than the driver's seat without a vehicle occupant being seated in the driver's seat, the amount of alleviation of the limitation may be configured to be reduced, or the limitation of the vehicle body behavior amount may be configured to be enhanced. In accordance with this feature, it is possible to realize a vehicle body behavior in consideration of only the riding comfort of vehicle occupants other than a driver of the vehicle.

The travel control device may be configured to acquire peripheral information of the vehicle, which is recognized by a periphery recognition device. Further, in a case that a traveling difficulty level, which is indicated by the peripheral information, belongs to a relatively high classification, or in a case that the traveling difficulty level is higher than a difficulty level threshold value, the travel control device may be configured to enhance the limitation on the vehicle body behavior amount. In accordance with this feature, the limitation on the vehicle body behavior amount accompanying the travel control is changed according to the traveling difficulty level. Therefore, a positive travel control fitting with the traveling difficulty level is made possible.

The peripheral information can include information of at least one of the presence or absence of another vehicle in vicinity of the vehicle, a traveling state of the other vehicle, an attribute of a travel lane, and a weather condition in the vicinity of the vehicle.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a block diagram showing a configuration of a vehicle including a travel electronic control unit serving as a travel control device according to a first embodiment of the present invention;

FIG. 2 is a flowchart showing the overall flow of an automatic driving control according to the first embodiment;

FIG. 3 is an explanatory diagram of a case in which there is, and a case in which there is not an alleviation of a lateral acceleration upper limit value, as well as a case in which an automatic lane change is performed in each of the aforementioned cases, respectively, in the first embodiment;

FIG. 4A is an explanatory diagram of a case in which an automatic lane change (ALC) is performed, for a case in which there is not an alleviation of a longitudinal acceleration upper limit value in the first embodiment;

FIG. 4B is an explanatory diagram of a case in which an ALC is performed, for a case in which there is an alleviation of the longitudinal acceleration upper limit value in the first embodiment;

FIG. 5 is a flowchart (details of step S15 in FIG. 2) for calculating output upper limit values of respective actuators in the first embodiment.

FIG. 6 is a block diagram showing a configuration of a vehicle including a travel electronic control unit serving as a travel control device according to a second embodiment of the present invention;

FIG. 7A is a diagram showing a state in which only one other vehicle exists in the vicinity of a user's own vehicle in the second embodiment;

FIG. 7B is a diagram showing a state in which four other vehicles exist in the vicinity of the user's own vehicle in the second embodiment; and

FIG. 8 is a flowchart (details of step S15 in FIG. 2) for calculating output upper limit values of respective actuators in the second embodiment.

### DESCRIPTION OF THE PREFERRED EMBODIMENTS

### A. First Embodiment

### <A-1. Configuration>

### [A-1-1. Overall Configuration]

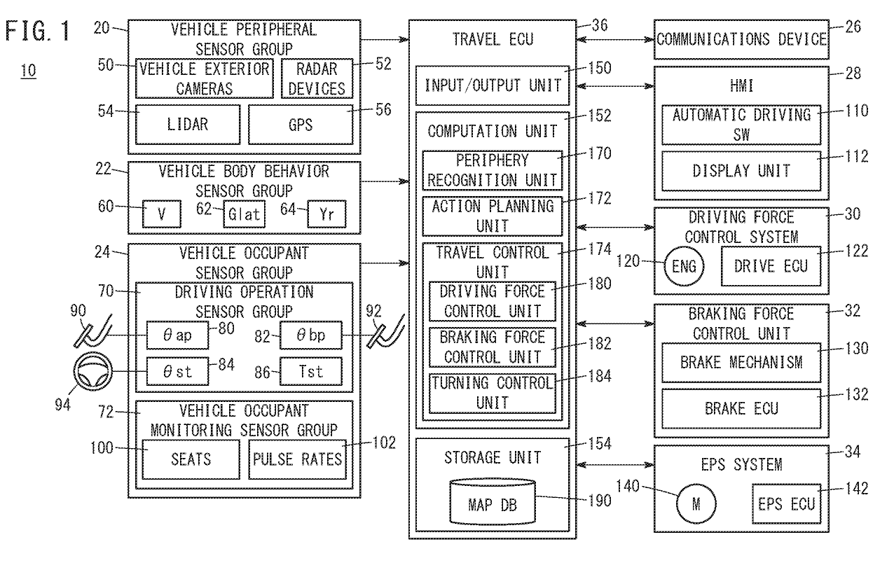

FIG. 1 is a block diagram showing the configuration of a vehicle 10 including a travel electronic control unit 36 (hereinafter referred to as a “travel ECU 36” or “ECU 36”) as a travel control device according to a first embodiment of the present invention. In addition to the travel ECU 36, the vehicle 10 (hereinafter also referred to as a “user's own vehicle 10”) includes a vehicle peripheral sensor group 20, a vehicle body behavior sensor group 22, a vehicle occupant sensor group 24, a communications device 26, a human-machine interface 28 (hereinafter referred to as an “HMI 28”), a driving force control system 30, a braking force control system 32, and an electric power steering system 34 (hereinafter referred to as an “EPS system 34”).

### [A-1-2. Vehicle Peripheral Sensor Group 20]

The vehicle peripheral sensor group 20 detects information in relation to the periphery of the vehicle 10 (hereinafter also referred to as “vehicle peripheral information Ic”). In the vehicle peripheral sensor group 20, there are included a plurality of vehicle exterior cameras 50, a plurality of radar devices 52, a LIDAR (Light Detection And Ranging) system 54, and a global positioning system sensor 56 (hereinafter referred to as a “GPS sensor 56”).

The plurality of vehicle exterior cameras 50 output image information Iimage obtained by capturing images of the periphery (front, sides, and rear) of the vehicle 10. The plurality of radar devices 52 output radar information Iradar indicative of reflected waves with respect to electromagnetic waves transmitted around the periphery (front, sides, and rear) of the vehicle 10. The LIDAR system 54 continuously irradiates a laser in all directions of the vehicle 10, measures the three-dimensional position of reflection points based on the reflected waves, and outputs the measurements as three-dimensional information Ilidar. The GPS sensor 56 detects the current position Pcur of the vehicle 10. The vehicle exterior cameras 50, the radar devices 52, the LIDAR system 54, and the GPS sensor 56 serve as periphery recognition devices that recognize the vehicle peripheral information Ic.

### [A-1-3. Vehicle Body Behavior Sensor Group 22]

The vehicle body behavior sensor group 22 detects information in relation to the behavior of the vehicle 10 (in particular, the vehicle body) (hereinafter also referred to as “vehicle body behavior information Ib”). The vehicle body behavior sensor group 22 includes a vehicle velocity sensor 60, a lateral acceleration sensor 62, and a yaw rate sensor 64.

The vehicle velocity sensor 60 detects the vehicle velocity V [km/h] of the vehicle 10. The lateral acceleration sensor 62 detects the lateral acceleration Glat [m/s/s] of the vehicle 10. The yaw rate sensor 64 detects the yaw rate Yr [rad/s] of the vehicle 10.

### [A-1-4. Vehicle Occupant Sensor Group 24]

The vehicle occupant sensor group 24 detects information in relation to vehicle occupants (including the driver and other persons) (hereinafter also referred to as “vehicle occupant information Ip”). The vehicle occupant sensor group 24 includes a driving operation sensor group 70 and a vehicle occupant monitoring sensor group 72.

The driving operation sensor group 70 detects information in relation to the driving operations performed by the driver (hereinafter also referred to as “driving operation information Io”). The driving operation sensor group 70 includes an accelerator pedal sensor 80, a brake pedal sensor 82, a steering angle sensor 84, and a steering torque sensor 86.

The accelerator pedal sensor 80 (hereinafter also referred to as an “AP sensor 80”) detects an operation amount θap (hereinafter also referred to as an “AP operation amount θap”) [%] of an accelerator pedal 90. The brake pedal sensor 82 (hereinafter also referred to as a “BP sensor 82”) detects an operation amount θbp (hereinafter also referred to as a “BP operation amount θbp”) [%] of a brake pedal 92. The steering angle sensor 84 detects a steering angle θst (hereinafter also referred to as an “operation amount θst”) [deg] of a steering wheel 94. The steering torque sensor 86 detects a steering torque Tst [N·m] applied to the steering wheel 94.

The vehicle occupant monitoring sensor group 72 detects information concerning the seated states (including seated positions) and the pulse rates Nb (times/min) of the vehicle occupants (hereinafter also referred to as “occupant state information Is”). The vehicle occupant monitoring sensor group 72 includes seat sensors 100 and pulse rate sensors 102.

The seat sensors 100 detect whether or not vehicle occupants are seated in each of the seats (driver's seat, a passenger seat, and rear seats), and output seat information Iseat indicating the results thereof. The seat sensors 100 are constituted as pressure sensors disposed at the bottom of each of the seats. Alternatively, the seat sensors 100 may be constituted as an in-vehicle camera that captures images of the interior of the vehicle. Alternatively, the seat sensors 100 may be constituted as seat belt sensors that detect whether or not the seat belts are fastened.

The pulse rate sensors 102 detect the pulse rates Nb of the vehicle occupants seated in each of the seats (driver's seat, the passenger seat, and rear seats), and outputs pulse rate information Inb indicating the results thereof. For example, the pulse rate sensors 102 may be constituted as ultrasonic sensors disposed inside backrest portions of each of the seats, which emit ultrasonic waves toward chest portions of the vehicle occupants, and detect the pulse rates Nb on the basis of reflected waves.

### [A-1-5. Communications Device 26]

The communications device 26 performs wireless communications with an external device. In this instance, the external device may include, for example, a non-illustrated traffic information server. The traffic information server supplies traffic information such as congestion information, accident information, construction information, and the like to respective vehicles 10. Alternatively, the external device may include a non-illustrated route guidance server. Instead of the travel ECU 36, the route guidance server generates or calculates a planned route Rv up to a target point Pgoal on the basis of the current position Pcur and the target point Pgoal of the vehicle 10, which are received from the communications device 26.

Moreover, although it is assumed that the communications device 26 of the first embodiment is mounted (or fixed at all times) in the vehicle 10, the communications device 26 may be, for example, a device that can be carried to locations outside of the vehicle 10, such as a mobile phone or a smart phone.

### [A-1-6. HMI 28]

The HMI 28 accepts operations input from a vehicle occupant, together with presenting various information to the vehicle occupant visually, audibly, and tactilely. The HMI 28 includes an automatic driving switch 110 (hereinafter also referred to as an “automatic driving SW 110”), and a display unit 112. The automatic driving SW 110 is a switch for issuing instructions by operations of the vehicle occupant to both initiate and terminate an automatic driving control. In addition to or in place of the automatic driving SW 110, it is also possible to instruct the initiation and termination of the automatic driving control by other methods (such as voice input via a non-illustrated microphone). The display unit 112 includes, for example, a liquid crystal panel or an organic EL panel. The display unit 112 may also be configured in the form of a touch panel.

### [A-1-7. Driving Force Control System 30]

The driving force control system 30 includes an engine 120 (drive source) and a drive electronic control unit 122 (hereinafter referred to as a “drive ECU 122”). The aforementioned AP sensor 80 and the accelerator pedal 90 may also be positioned as components of the driving force control system 30. The drive ECU 122 executes a driving force control for the vehicle 10 using the AP operation amount θap, etc. When the driving force control is implemented, the drive ECU 122 controls a travel driving force Fd of the vehicle 10 through the control of the engine 120.

### [A-1-8. Braking Force Control System 32]

The braking force control system 32 includes a brake mechanism 130 and a brake electronic control unit 132 (hereinafter referred to as a “brake ECU 132”). The aforementioned BP sensor 82 and the brake pedal 92 may be considered as components of the braking force control system 32. The brake mechanism 130 actuates a brake member by a brake motor (or a hydraulic mechanism) or the like.

The brake ECU 132 executes a braking force control for the vehicle 10 using the BP operation amount θbp, etc. When the braking force control is implemented, the brake ECU 132 controls the braking force Fb of the vehicle 10 through the control of the brake mechanism 130, etc.

### [A-1-9. EPS System 34]

The EPS system 34 includes an EPS motor 140 and an EPS electronic control unit 142 (hereinafter referred to as an “EPS ECU 142” or an “ECU 142”). The aforementioned steering angle sensor 84, the steering torque sensor 86, and the steering wheel 94 may be considered as components of the EPS system 34.

The EPS ECU 142 controls the EPS motor 140 according to commands from the travel ECU 36, and thereby controls a turning amount R of the vehicle 10. In the turning amount R, there are included the steering angle θst, the lateral acceleration Glat, and the yaw rate Yr.

### [A-1-10. Travel ECU 36]

### (A-1-10-1. Outline of Travel ECU 36)

The travel ECU 36 executes the automatic driving control for driving the vehicle 10 to the target point Pgoal without requiring driving operations made by the driver, and for example, includes a central processing unit (CPU). The ECU 36 includes an input/output unit 150, a computation unit 152, and a storage unit 154.

Moreover, portions of the functions of the travel ECU 36 can be borne by an external device existing externally of the vehicle 10. For example, the vehicle 10 itself may be configured not to include an action planning unit 172 and/or a map database 190, to be described later, and to acquire the planned route Rv and/or the map information Imap from the aforementioned route guidance server.

### (A-1-10-2. Input/Output Unit 150)

The input/output unit 150 performs input and output operations with respect to devices apart from the ECU 36 (the sensor groups 20, 22, 24, the communications device 26, etc.). The input/output unit 150 includes a non-illustrated A/D conversion circuit that converts input analog signals into digital signals.

### (A-1-10-3. Computation Unit 152)

The computation unit 152 carries out calculations based on signals received from the sensor groups 20, 22, 24, the communications device 26, the HMI 28, and the ECUs 122, 132, 142, etc. In addition, based on the calculation results thereof, the computation unit 152 generates and outputs signals with respect to the communications device 26, the drive ECU 122, the brake ECU 132, and the EPS ECU 142.

As shown in FIG. 1, the computation unit 152 of the travel ECU 36 includes a periphery recognition unit 170, the action planning unit 172, and a travel control unit 174. These respective components are realized by executing a program stored in the storage unit 154. The program may be supplied from an external device via the communications device 26. Portions of the program may also be constituted by hardware (circuit components).

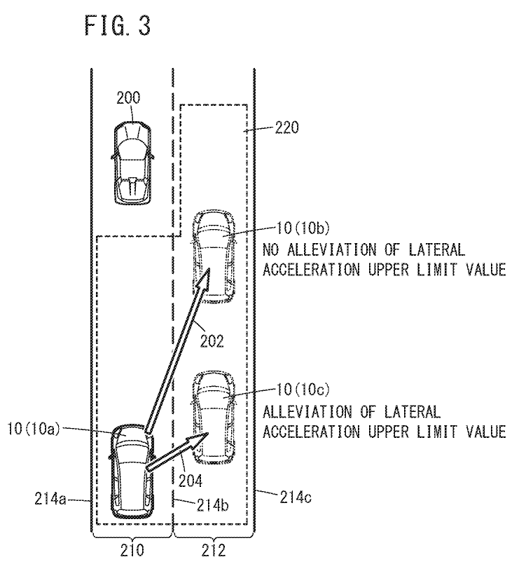

The periphery recognition unit 170 recognizes lane markings (lane markings 214a to 214c and the like, as shown in FIG. 3) and peripheral objects (another vehicle 200 and the like, as shown in FIG. 3) on the basis of the vehicle peripheral information Ic received from the vehicle peripheral sensor group 20. For example, the lane markings are recognized based on the image information Iimage. Based on the recognized lane markings, the periphery recognition unit 170 recognizes the travel lane of the vehicle 10 (a travel lane 210 shown in FIG. 3, etc.).

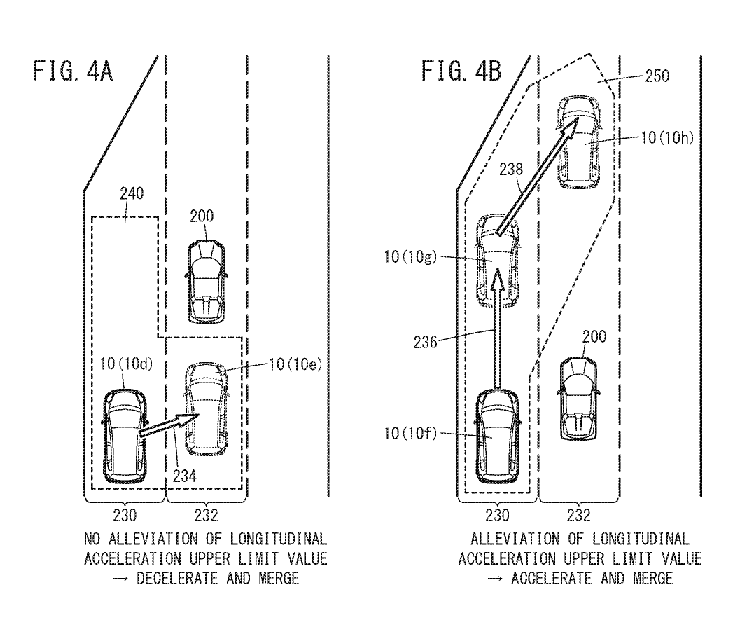

Further, the peripheral objects are recognized using the image information Iimage, the radar information Iradar, and the three-dimensional information Ilidar. Among the peripheral objects, there are included moving objects such as other vehicles (the other vehicle 200, etc., shown in FIG. 3 and FIG. 4), and stationary objects such as buildings, signs (for example, traffic signals), and the like. In the case that the peripheral object is a traffic signal, the periphery recognition unit 170 determines the color of the traffic signal.

Through the HMI 28, the action planning unit 172 calculates the planned route Rv for the user's own vehicle 10 up to the target point Pgoal, and performs route guidance along the planned route Rv.

The travel control unit 174 controls the outputs of each of respective actuators that control the vehicle body behavior. Among such actuators, there are included the engine 120, the brake mechanism 130, and the EPS motor 140. By controlling the outputs of the actuators, the travel control unit 174 controls behavior amounts (hereinafter referred to as “vehicle body behavior amounts Qb”) of the vehicle 10 (in particular, the vehicle body).

Among the vehicle body behavior amounts Qb referred to herein, there are included the vehicle velocity V, a longitudinal acceleration α (hereinafter also referred to as an “acceleration α”) [m/s/s], a longitudinal deceleration β (hereinafter also referred to as a “deceleration β”) [m/s/s], a steering angle θst, a lateral acceleration Glat, and a yaw rate Yr. The acceleration α and the deceleration β can be calculated as time differential values of the vehicle velocity V.

The travel control unit 174 includes a driving force control unit 180, a braking force control unit 182, and a turning control unit 184. The driving force control unit 180 primarily controls the output of the engine 120, and thereby controls the travel driving force Fd (or the acceleration α) of the vehicle 10. The braking force control unit 182 primarily controls the output of the brake mechanism 130, and thereby controls the braking force Fb (or deceleration β) of the vehicle 10. The turning control unit 184 primarily controls the output of the EPS motor 140, and thereby controls the turning amount R (or the steering angle θst, the lateral acceleration Glat, and the yaw rate Yr) of the vehicle 10.

### (A-1-10-4. Storage Unit 154)

The storage unit 154 stores programs and data (including the map database 190) used by the computation unit 152. Road map information (map information Imap) is stored in the map database 190 (hereinafter referred to as a “map DB 190”). In the map information Imap, there is included road information Iroad concerning the shapes of roads and the like.

The storage unit 154 includes, for example, a random access memory (hereinafter referred to as a “RAM”). As the RAM, a volatile memory such as a register or the like, and a nonvolatile memory such as a flash memory or the like can be used. Further, in addition to the RAM, the storage unit 154 may have a read only memory (hereinafter referred to as a “ROM”).

### <A-2. Automatic Driving Control of the First Embodiment>

### [A-2-1. Outline of Automatic Driving Control of the First Embodiment]

As described above, the travel ECU 36 of the first embodiment executes the automatic driving control. In the automatic driving control, the vehicle 10 is driven to a target point Pgoal without requiring driving operations made by the driver. However, in the automatic driving control, if the driver operates the accelerator pedal 90, the brake pedal 92, or the steering wheel 94, changes are carried out in accordance with such operations.

More specifically, in the case that the operation amount θap of the accelerator pedal 90 is comparatively small, the ECU 36 alleviates or relaxes the upper limit value αmax of the longitudinal acceleration α. In the case that the operation amount θbp of the brake pedal 92 is comparatively small, the ECU 36 alleviates or relaxes the upper limit value θmax of the longitudinal deceleration β. When the AP operation amount θap or the BP operation amount θbp becomes comparatively large, the ECU 36 hands over operation of the longitudinal acceleration α and the longitudinal deceleration β to the driver. Details of these features will be described later with reference to FIGS. 3 to 5.

In the case that the operation amount (steering angle θst) of the steering wheel 94 is comparatively small, the ECU 36 alleviates or relaxes the upper limit values θstmax and Glatmax of the steering angle θst and the lateral acceleration Glat. When the operation amount (steering angle θst) of the steering wheel 94 becomes comparatively large, the ECU 36 hands over operation of the steering angle θst to the driver.

In the automatic driving control according to the first embodiment, the automatic driving force control, the automatic braking force control, and the automatic turning control are used in combination.

The automatic driving force control automatically controls the travel driving force Fd of the vehicle 10. The automatic braking force control automatically controls the braking force Fb of the vehicle 10. The automatic turning control automatically controls turning of the vehicle 10. Turning of the vehicle 10 as referred to herein includes not only the case of traveling on a curved road, but also right and left turning of the vehicle 10, as well as making a change of a travel lane, merging into another lane, and maintenance of the travel lane. Moreover, turning for the purpose of maintaining the travel lane implies turning (or steering) of the vehicle 10 in a vehicle widthwise direction, so as to maintain the vehicle 10 at a reference position (for example, a center position in the vehicle widthwise direction).

The automatic driving force control automatically causes the vehicle 10 to undergo traveling by controlling the travel driving force Fd. At this time, the ECU 36 sets a target value (for example, a target engine torque) of the travel driving force Fd, and controls an actuator (the engine 120) in accordance with the target value. Further, the ECU 36 sets an upper limit value αmax (hereinafter also referred to as a “longitudinal acceleration upper limit value αmax” or an “acceleration upper limit value αmax”) of the longitudinal acceleration α of the vehicle 10, and controls the travel driving force Fd so that the longitudinal acceleration α does not exceed the upper limit value αmax. As will be discussed later, the acceleration upper limit value αmax is made variable in accordance with the vehicle velocity V.

The automatic braking force control decelerates the vehicle 10 by controlling the braking force Fb of the vehicle 10. At this time, the ECU 36 sets a target value (for example, a target deceleration βtar) of the braking force Fb, and controls an actuator (the brake mechanism 130) in accordance with the target value. Further, the ECU 36 sets an upper limit value βmax (hereinafter also referred to as a “deceleration upper limit value βmax”) of the deceleration β of the vehicle 10, and controls the braking force Fb so that the deceleration β does not exceed the upper limit value βmax (so that deceleration does not take place too rapidly). As will be discussed later, the deceleration upper limit value βmax is made variable in accordance with the vehicle velocity V.

In the automatic turning control, the turning amount R of the vehicle 10 is controlled in order to turn the vehicle 10. At this time, the ECU 36 sets a target value of the turning amount R (for example, a target steering angle θsttar or a target lateral acceleration Glattar), and controls an actuator (the EPS motor 140) in accordance with the target value. Further, the ECU 36 sets an upper limit value Rmax (hereinafter also referred to as a “turning amount upper limit value Rmax”) of the turning amount R of the vehicle 10, and controls the turning amount R so that the turning amount R does not exceed the upper limit value Rmax. The upper limit value Rmax of the turning amount, for example, is used in the form of an upper limit value θstmax (hereinafter also referred to as a “steering angle upper limit value θstmax”) of the steering angle θst, or an upper limit value Glatmax (hereinafter referred to as a “lateral acceleration upper limit value Glatmax”) of the lateral acceleration Glat. As will be discussed later, the turning amount upper limit value Rmax is made variable in accordance with the vehicle velocity V.

### [A-2-2. Overall Flow of Automatic Driving Control of the First Embodiment]

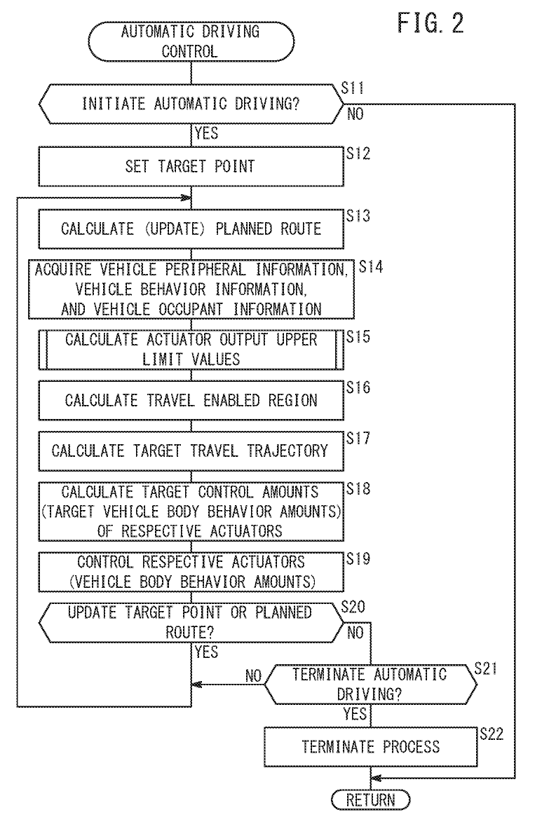

FIG. 2 is a flowchart showing the overall flow of the automatic driving control according to the first embodiment. In step S11, the travel ECU 36 determines whether or not to initiate automatic driving. For example, the ECU 36 determines whether or not the automatic driving switch 110 (see FIG. 1) has been switched from off to on. In the case that automatic driving is to be initiated (step S11: YES), the process proceeds to step S12. In the case that automatic driving is not to be initiated (step S11: NO), the current process is terminated, and after a predetermined time period has elapsed, the process returns to step S11.

In step S12, the ECU 36 sets the target point Pgoal. More specifically, an input of the target point Pgoal from the user (driver, etc.) is received via the HMI 28. In step S13, the ECU 36 calculates a planned route Rv from the current position Pcur to the target point Pgoal. Moreover, in the event that step S13 is performed after the later-described step S21, the ECU 36 updates the planned route Rv.

In step S14, the ECU 36 acquires from the sensor groups 20, 22, 24 the vehicle peripheral information Ic, the vehicle body behavior information Ib, and the vehicle occupant information Ip. As noted above, in the vehicle peripheral information Ic, there are included the image information Iimage from the vehicle exterior cameras 50, the radar information Iradar from the radar devices 52, the three-dimensional information Ilidar from the LIDAR system 54, and the current position Pcur from the GPS sensor 56. In the vehicle body behavior information Ib, there are included the vehicle velocity V from the vehicle velocity sensor 60, the lateral acceleration Glat from the lateral acceleration sensor 62, and the yaw rate Yr from the yaw rate sensor 64. In the driving operation information Io, there are included the AP operation amount θap from the AP sensor 80, the BP operation amount θbp from the BP sensor 82, the steering angle θst from the steering angle sensor 84, and the steering torque Tst from the steering torque sensor 86.

In step S15, the ECU 36 calculates output upper limit values Pmax for each of the actuators. Among such actuators, there are included the engine 120, the brake mechanism 130, and the EPS motor 140.

Further, the upper limit value Pmax of the output Peng of the engine 120 (hereinafter also referred to as an “output upper limit value Pengmax”), for example, is an upper limit value of the torque of the engine 120. The upper limit value Pmax of the output Pb of the brake mechanism 130 (hereinafter also referred to as an “output upper limit value Pbmax”), for example, is an upper limit value of the braking force Fb. The upper limit value Pmax of the output Peps of the EPS motor 140 (hereinafter also referred to as an “output upper limit value Pepsmax”), for example, is an upper limit value of the torque of the EPS motor 140. By using these output upper limit values Pmax (Pengmax, Pbmax, Pepsmax), it is possible to avoid excessive outputs, and the riding comfort or the like of the vehicle occupants can be increased.

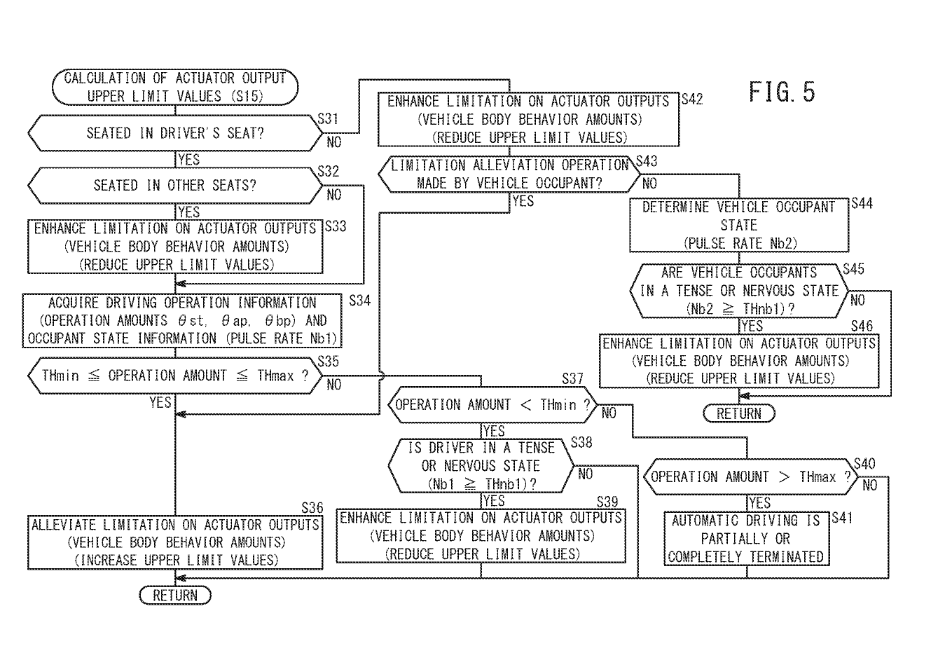

The output upper limit values Pmax are calculated based on the upper limit values Qbmax of the vehicle body behavior amounts Qb. In step S15 of the first embodiment, a limit control is implemented to switch the output upper limit values Pmax depending on the vehicle velocity V (details of this feature will be described later with reference to FIG. 5).

In step S16, the ECU 36 calculates a travel enabled region (a travel enabled region 220 shown in FIG. 3, etc.). The travel enabled region is indicative of a region within which the vehicle 10 is capable of traveling at the present time. For example, a region is indicated in which the distance between the vehicle 10 and each of respective peripheral objects is greater than or equal to a predetermined value, with reference to a reference point of the vehicle 10 (for example, the center of gravity of the vehicle 10, or the center of a line segment connecting the left and right rear wheels). Alternatively, the vehicle 10 may be represented by a rectangle as viewed in plan, and for each of the four corners of such a rectangle, a region may be used in which the distance to each of the respective peripheral objects is greater than or equal to a predetermined value.

In calculating the travel enabled region, a relationship of the vehicle 10 with the peripheral objects (in particular, a front object) (the other vehicle 200 in FIG. 3, etc.) is also taken into consideration. In relation to the front object, the ECU 36 carries out a forward monitoring control. The forward monitoring control will be described later with reference to FIG. 3.

Moreover, in the case that the periphery recognition unit 170 recognizes a red light, an area ahead of a stop line in front of the traffic light can be excluded from the travel enabled region. Alternatively, the travel enabled region may be calculated simply on the basis of a relationship (distance or the like) with the peripheral objects, and a travel restriction in accordance with the red light may be reflected when calculating a target travel trajectory Ltar, as will be described later.

Further, in step S16 of the present embodiment, a limit control is implemented to switch the travel enabled region depending on the vehicle velocity V (details of this feature will be described later with reference to FIG. 5).

In step S17, the ECU 36 calculates the target travel trajectory Ltar (hereinafter also referred to as a “target trajectory Ltar”). The target trajectory Ltar is a target value of the travel trajectory L for the vehicle 10. In the first embodiment, an optimal trajectory is selected as the target trajectory Ltar from among travel trajectories L in the travel enabled region that satisfy various conditions.

In step S18, the ECU 36 calculates, on the basis of the target trajectory Ltar, target control amounts (in other words, target vehicle body behavior amounts Qbtar) for the respective actuators. In the target vehicle body behavior amounts Qbtar, there are included, for example, a target longitudinal acceleration αtar, a target longitudinal deceleration βtar, and a target lateral acceleration Glattar.

In step S19, using the target control amounts calculated in step S18, the ECU 36 controls the respective actuators (in other words, the vehicle body behavior amounts Qb). For example, the driving force control unit 180 calculates a target output Pengtar (for example, a target engine torque) for the engine 120 (actuator) so as to realize the target longitudinal acceleration αtar. In addition, the driving force control unit 180 controls the engine 120 via the drive ECU 122 so as to realize the target output Pengtar.

Further, the braking force control unit 182 calculates the target output Pbtar of the brake mechanism 130 (actuator) so as to realize the target longitudinal deceleration Var. In addition, the braking force control unit 182 controls the brake mechanism 130 via the brake ECU 132 so as to realize the target output Pbtar.

Furthermore, the turning control unit 184 sets the target steering angle θsttar so as to realize the target lateral acceleration Glattar. In addition, the turning control unit 184 controls the EPS motor 140 (actuator) via the EPS ECU 142 so as to realize the target steering angle θsttar. Moreover, in addition to or instead of carrying out turning by way of the EPS motor 140, it is also possible to cause the vehicle 10 to turn (so-called torque vectoring) by way of a torque difference between the left and right wheels.

In step S20, the ECU 36 determines whether or not to change the target point Pgoal or the planned route Rv. The case of changing the target point Pgoal is a case in which a new target point Pgoal is input through operation of the HMI 28. The case of changing the planned route Rv, for example, is a case in which traffic congestion occurs in the planned route Rv, and thus it becomes necessary to set a detour route. The occurrence of traffic congestion can be recognized, for example, using congestion information acquired from the traffic information server via the communications device 26.

If the target point Pgoal or the planned route Rv is changed (step S20: YES), the process returns to step S13 and a planned route Rv is calculated on the basis of the new target point Pgoal, or a new planned route Rv is calculated. If the target point Pgoal or the planned route Rv is not changed (step S20: NO), the process proceeds to step S21.

In step S21, the travel ECU 36 determines whether or not to terminate automatic driving. Termination of automatic driving takes place, for example, in the case that the vehicle 10 has arrived at the target point Pgoal, or in the case that the automatic driving switch 110 has been switched from on to off. Alternatively, if the surrounding environment has become an environment in which automatic driving is difficult, the ECU 36 terminates automatic driving.

In the case that automatic driving is not terminated (step S21: NO), the process returns to step S13, and the ECU 36 updates the planned route Rv based on the current position Pcur. In the case that automatic driving is to be terminated (step S21: YES), the process proceeds to step S22.

In step S22, the ECU 36 executes a termination process. More specifically, if the vehicle 10 has arrived at the target point Pgoal, the ECU 36 notifies the driver, etc., via the HMI 28 and by way of voice, a display, or the like that the vehicle 10 has arrived at the target point Pgoal. In the event that the automatic driving switch 110 is switched from ON to OFF, the ECU 36 notifies the driver, etc., via the HMI 28 and by way of voice, a display, or the like that automatic driving is to be terminated. If the surrounding environment has become an environment in which driving is difficult, the ECU 36 notifies the driver, etc., of that fact via the HMI 28 and by way of voice, a display, or the like.

### [A-2-3. Calculation of Respective Output Upper Limit Values Pmax (Step S15 of FIG. 2)]

### (A-2-3-1. Basic Concept)

FIG. 3 is an explanatory diagram of a case in which there is, and a case in which there is not an alleviation of the lateral acceleration upper limit value Glatmax, as well as a case in which an automatic lane change (ALC) is performed in each of such cases, respectively, according to the first embodiment. In FIG. 3, there are shown three instances of the user's own vehicle 10 (in order to distinguish them from each other, the vehicles are also referred to as “user's own vehicles 10a to 10c”), and one other vehicle 200 (hereinafter also referred to as a “preceding vehicle 200”).

The user's own vehicle 10a shown by the solid line represents the user's own vehicle 10 before changing lanes and while traveling in the travel lane 210. The user's own vehicles 10b, 10c shown by the two-dot-chain lines represent the user's own vehicle 10 after having made a lane change and while traveling in a new travel lane 212. The travel lane 210 is specified by the lane markings 214a and 214b. The travel lane 212 is specified by the lane markings 214b and 214c.

Arrows 202 and 204 show in simplified form the movement of the user's own vehicle 10 when making a lane change. The travel enabled region 220 shown in FIG. 3 is calculated in step S16 of FIG. 2 with reference to the user's own vehicle 10a.

Further, the user's own vehicle 10b is the user's own vehicle 10 for a case in which the lateral acceleration upper limit value Glatmax has not been alleviated. The user's own vehicle 10c is the user's own vehicle 10 for a case in which the lateral acceleration upper limit value Glatmax has been alleviated.

Alleviation of the lateral acceleration upper limit value Glatmax as referred to herein implies that the lateral acceleration upper limit value Glatmax is increased in accordance with an additional operation of the steering wheel 94 made by the driver. Moreover, it should be kept in mind that the alleviation of the lateral acceleration upper limit value Glatmax is not started when the automatic lane change (ALC) of FIG. 3 is made, but rather starting thereof occurred in an ALC that took place before the ALC of FIG. 3. However, immediately prior to the start of the ALC in FIG. 3, the lateral acceleration upper limit value Glatmax may be increased by an additional operation made by the driver.

In comparison with the user's own vehicle 10b, the user's own vehicle 10c is capable of completing the ALC at an earlier time. Accordingly, it is easy for the intention of the driver in relation to steering to be reflected.

FIG. 4A is an explanatory diagram of a case in which an automatic lane change ALC is performed, for a case in which there is not an alleviation of the longitudinal acceleration upper limit value αmax in the first embodiment. FIG. 4B is an explanatory diagram of a case in which an automatic lane change ALC is performed, for a case in which there is an alleviation of the longitudinal acceleration upper limit value αmax in the first embodiment. In FIG. 4A, there are shown two instances of the user's own vehicle 10 (in order to distinguish them from each other, the vehicles are also referred to as “user's own vehicles 10d and 10e”), and one preceding vehicle 200. The user's own vehicle 10d represents the user's own vehicle 10 before the ALC and while traveling in a travel lane 230. The user's own vehicle 10e represents the user's own vehicle 10 after the ALC and while traveling in a travel lane 232. An arrow 234 shows in simplified form a movement aspect of the user's own vehicle 10. A travel enabled region 240 shown in FIG. 4A is calculated in step S16 of FIG. 2 with reference to the user's own vehicle 10d.

In FIG. 4B, there are shown three instances of the user's own vehicle 10 (in order to distinguish them from each other, the vehicles are also referred to as “user's own vehicles 10f to 10h”), and one preceding vehicle 200. The user's own vehicle 10f represents the user's own vehicle 10 before the ALC and while traveling in the travel lane 230. The user's own vehicle 10g represents the user's own vehicle 10 during the ALC and while traveling in the travel lane 230 with acceleration. The user's own vehicle 10h represents the user's own vehicle 10 after the ALC and while traveling in the travel lane 232. Arrows 236, 238 show in simplified form a movement aspect of the user's own vehicle 10. A travel enabled region 250 shown in FIG. 4B is calculated in step S16 of FIG. 2 with reference to the user's own vehicle 10f.

Alleviation of the longitudinal acceleration upper limit value αmax implies that the acceleration upper limit value αmax is increased in accordance with an additional operation of the accelerator pedal 90 made by the driver. Moreover, it should be kept in mind that the alleviation of the acceleration upper limit value αmax is not started when the automatic lane change (ALC) of FIG. 4B is made, but rather starting thereof occurred in an ALC that took place before the ALC of FIG. 4B. However, immediately prior to the start of the ALC in FIG. 4B, the acceleration upper limit value αmax may be increased by an additional operation made by the driver.

In FIG. 4A, alleviation of the acceleration upper limit value αmax is not carried out. Therefore, in order to avoid the preceding vehicle 200, the vehicle 10 decelerates and merges into the lane 232. On the other hand, in the case of FIG. 4B, alleviation of the acceleration upper limit value αmax is carried out. Therefore, in order to avoid the preceding vehicle 200, it is possible to accelerate and then merge into the lane 232. Accordingly, by alleviating the acceleration upper limit value αmax, it is easy for the intention of the driver in relation to merging to be reflected.

### (A-2-3-2. Specific Method of Calculating Output Upper Limit Values Pmax)

FIG. 5 is a flowchart (details of step S15 in FIG. 2) for calculating output upper limit values Pmax of the respective actuators in the first embodiment. In step S31, the travel ECU 36 determines whether or not a vehicle occupant (the driver) is seated in the driver's seat on the basis of seat information Iseat from the seat sensors 100. If the driver is seated in the driver's seat (step S31: YES), the process proceeds to step S32.

In step S32, the travel ECU 36 determines whether or not a vehicle occupant is seated in a seat (a passenger seat, a rear seat) other than the driver's seat on the basis of the seat information Iseat from the seat sensors 100. If a vehicle occupant is seated in a seat other than the driver's seat (step S32: YES), the process proceeds to step S33. If a vehicle occupant is not seated in a seat other than the driver's seat (step S32: NO), the process proceeds to step S34.

In step S33, the ECU 36 enhances the limitation on the outputs (or the vehicle body behavior amounts Qb) of the actuators (the engine 120, the brake mechanism 130, and/or the EPS motor 140). Stated otherwise, the ECU 36 decreases the output upper limit values Pmax.

In step S34, the ECU 36 acquires the driving operation information Io and the vehicle occupant state information Is. In this instance, in the driving operation information Io, there are included the operation amount θst of the steering wheel 94, the operation amount θap of the accelerator pedal 90, and the operation amount θbp of the brake pedal 92. Further, in the vehicle occupant state information Is, there is included the pulse rate Nb1 of the driver. As will be discussed later, other information may also be used as the driving operation information Io or the vehicle occupant state information Is.

In step S35, the ECU 36 determines whether or not the operation amounts θap, θbp, and θst are greater than or equal to the operation amount lower limit values THθapmin, THθbpmin, and THθstmin, and less than or equal to the operation amount upper limit values THθapmax, THθbpmax, and THθstmax. Hereinafter, the operation amount lower limit values THθapmin, THθbpmin, and THθstmin will be referred to collectively as operation amount lower limit values THmin. Further, the operation amount upper limit values THθapmax, THθbpmax, and THθstmax will be referred to collectively as operation amount upper limit values THmax. The determination of step S35 is performed respectively for each of the operation amounts θap, θbp, and θst.

If the operation amounts θap, θbp, θst are greater than or equal to the operation amount lower limit values THmin and less than or equal to the operation amount upper limit values THmax (step S35: YES), the process proceeds to step S36. In step S36, the ECU 36 alleviates or relaxes the limitation on the outputs (or the vehicle body behavior amounts Qb) of the actuators (the engine 120, the brake mechanism 130, and/or the EPS motor 140). Stated otherwise, the ECU 36 increases the output upper limit values Pmax.

If the operation amounts θap, θbp, θst fall below the operation amount lower limit values THmin or exceed the operation amount upper limit values THmax (step S35: NO), the process proceeds to step S37. In step S37, the ECU 36 determines whether or not the operation amounts θap, θbp, θst fall below the operation amount lower limit values THmin. If the operation amounts θap, θbp, θst fall below the operation amount lower limit values THmin (step S37: YES), the process proceeds to step S38.

In step S38, the ECU 36 determines whether or not the driver is in a tense or nervous state. More specifically, the ECU 36 determines whether or not the pulse rate Nb1 of the driver is greater than or equal to a first pulse rate threshold value THnb1. If the driver is in a tense or nervous state (step S38: YES), the process proceeds to step S39. If the driver is not in a tense or nervous state (step S38: NO), then the current process is brought to an end.

In step S39, the ECU 36 enhances the limitation on the outputs (or the vehicle body behavior amounts Qb) of the actuators (the engine 120, the brake mechanism 130, and/or the EPS motor 140). Stated otherwise, the ECU 36 decreases the output upper limit values Pmax.

Returning to step S37, if the operation amounts θap, θbp, θst do not fall below the operation amount lower limit values THmin (step S37: NO), the process proceeds to step S40. In step S40, the ECU 36 determines whether or not the operation amounts θap, θbp, θst have exceeded the operation amount upper limit values THmax. If the operation amounts θap, θbp, θst have exceeded the operation amount upper limit values THmax (step S40: YES), the process proceeds to step S41. If the operation amounts θap, θbp, θst have not exceeded the operation amount upper limit values THmax (step S40: NO), then the current process is brought to an end.

In step S41, the ECU 36 partially or completely terminates the automatic operations. More specifically, if the AP operation amount θap exceeds the operation amount upper limit value THmax, the ECU 36 hands over control of the longitudinal acceleration α to the driver (in other words, the control is switched over to manual operation). If the BP operation amount θbp exceeds the operation amount upper limit value THmax, the ECU 36 hands over control of the deceleration β to the driver. If the operation amount θst of the steering wheel 94 is in excess of the operation amount upper limit value THmax, the ECU 36 hands over control of the turning amount R (operation amount θst, etc.) to the driver.

Moreover, if any one of the operation amounts θap, θbp, θst is in excess of its operation amount upper limit value THmax, the ECU 36 may terminate all of the automatic operations related to acceleration, deceleration, and turning.

Returning to step S31 in FIG. 5, in the event that the driver is not seated in the driver's seat (step S31: NO), the process proceeds to step S42. In step S42, the ECU 36 enhances the limitation on the outputs (or the vehicle body behavior amounts Qb) of the actuators. More specifically, the ECU 36 decreases the output upper limit values Pmax. Moreover, the limitation in step S42 is set to be stronger than the limitation in step S33. Stated otherwise, the decreased amounts (regulated amounts) of the output upper limit values Pmax are large. Alternatively, the limitation in step S42 can be set to be equal to or weaker than the limitation in step S33.

In step S43, the ECU 36 determines whether or not a limitation alleviation operation by the occupant has been performed. The limitation alleviation operation is an operation by a vehicle occupant to request alleviation of the limitation on the actuator outputs (or the vehicle body behavior amounts Qb). The limitation alleviation operation is input by the HMI 28 (via a non-illustrated operation button or the like). In the case that the limitation alleviation operation by the vehicle occupant has been performed (step S43: YES), the process proceeds to step S36, whereupon the limitation on the actuator outputs (the vehicle body behavior amounts Qb) is alleviated. More specifically, the ECU 36 increases the output upper limit values Pmax. If the limitation alleviation operation has not been performed by the vehicle occupant (step S43: NO), the process proceeds to step S44.

In step S44, the ECU 36 determines the vehicle occupant state in relation to vehicle occupants (other than the driver). The ECU 36 acquires the pulse rates Nb2 from the pulse rate sensors 102 in relation to vehicle occupants other than the driver.

In step S45, the ECU 36 determines whether or not a vehicle occupant other than the driver is in a tense or nervous state. More specifically, the ECU 36 determines whether or not the pulse rate Nb2 is greater than or equal to a second pulse rate threshold value THnb2. In the same manner as the first pulse rate threshold value THnb1, the second pulse rate threshold value THnb2 is a threshold value for determining whether or not the vehicle occupant is in a tense or nervous state. If the vehicle occupant is in a tense or nervous state (step S45: YES), the process proceeds to step S46. If the vehicle occupant is not in a tense or nervous state (step S45: NO), the current process is terminated, and after a predetermined time period has elapsed, the process returns to step S31.

In step S46, the ECU 36 enhances the limitation on the outputs (or the vehicle body behavior amounts Qb) of the actuators. More specifically, the ECU 36 decreases the output upper limit values Pmax. Moreover, the limitation in step S46 is set to be stronger than the limitation in steps S33 and S42. Stated otherwise, the decreased amounts (regulated amounts) of the output upper limit values Pmax are large. Alternatively, the limitation in step S46 can be set to be equal to or weaker than the limitation in steps S33 and S42.

### <A-3. Advantages and Effects of the First Embodiment>

As described above, according to the first embodiment, the limitation on the actuators (or the vehicle body behavior amounts Qb) during automatic driving is alleviated in accordance with the operation amounts θap, θbp, θst (the state of the vehicle occupants) (step S36 of FIG. 5). Stated otherwise, the limitation on the actuators (or the vehicle body behavior amounts Qb) is made to change depending on the state of the vehicle occupant. Therefore, a positive travel control fitting with the sensations of the vehicle occupant is made possible.

In the first embodiment, the ECU 36 (travel control device) acquires as the state of the vehicle occupant the operation amounts θst, θap, θbp of turning, acceleration or deceleration by the vehicle occupant (step S34 of FIG. 5). Further, the ECU 36 alleviates the limitation on the actuators (or the vehicle body behavior amounts Qb) targeted by the operation amounts θst, θap, θbp in accordance with an increase in the operation amounts θst, θap, θbp (step S36).

In accordance with this feature, it becomes possible to change the limitation on the actuator outputs (or vehicle body behavior amounts Qb) depending on the intention of the vehicle occupant in relation to turning (including steering), acceleration, or deceleration. Consequently, it is possible to reduce a feeling of unease or discomfort felt by the vehicle occupant in relation to the actuator outputs (or vehicle body behavior amounts Qb).

In the first embodiment, if the operation amounts θst, θap, θbp exceed their operation amount upper limit values THmax (step S40: YES in FIG. 5), the ECU 36 (travel control device) switches the operation of the operation amounts θst, θap, θbp to manual (step S41). In accordance with this feature, in the case it is possible to determine that the driver is intending to perform an operation at the operation amounts θst, θap, θbp, operability can be enhanced by handing over the responsibility for the operation at the operation amounts θst, θap, θbp to the driver.

In the first embodiment, the ECU 36 (travel control device) limits the actuator outputs (or the vehicle body behavior amounts Qb) (step S39 or step S46), when it is determined that the pulse rates Nb1, Nb2 (states of the vehicle occupants) detected by the pulse rate sensors 102 (vehicle occupant sensors) indicate that the vehicle occupants are in a tense or nervous state (step S38: YES or step S45: YES). In accordance with this feature, by limiting the actuator outputs (or the vehicle body behavior amounts Qb) when the vehicle occupants are in a tense or nervous state due to the behavior of the vehicle body, which is being driven automatically, the state of tension or nervousness of the vehicle occupants can be reduced.

In the first embodiment, the ECU 36 (travel control device) alleviates the limitation on the actuator outputs (or the vehicle body behavior amounts Qb), in the case that the driver is seated in the driver's seat (step S31 of FIG. 5: YES), or stated otherwise, based on the seated positions of the vehicle occupants as detected by the seat sensors 100 (step S36). In accordance with this feature, it is possible to set appropriate actuator outputs (or vehicle body behavior amounts Qb) depending on which seat a vehicle occupant/occupants is/are seated, in the driver's seat, a passenger seat, or a rear seat.

In the first embodiment, in the case that a vehicle occupant is seated in a seat other than the driver's seat (step S31 of FIG. 5: NO or step S32: YES), the ECU 36 (travel control device) enhances the limitation on the actuator outputs (or the vehicle body behavior amounts Qb) (steps S33 and S42 of FIG. 5). In accordance with this feature, in the case that vehicle occupants other than the driver are on board the vehicle, it is possible to improve riding comfort for the vehicle occupants other than the driver by carrying out traveling in a more gentle manner.

In the first embodiment, in comparison with a case in which vehicle occupants are seated in both the driver's seat and the seat other than the driver's seat (step S31: YES step S32: YES), in the case that a vehicle occupant is seated in a seat other than the driver's seat without a vehicle occupant being seated in the driver's seat (step S31: NO), the ECU 36 (travel control device) enhances the limitation on the actuator outputs (vehicle body behavior amounts Qb) (steps S33, S42, S46). In accordance with this feature, it is possible to realize a vehicle body behavior in consideration of only the riding comfort of vehicle occupants other than a driver of the vehicle.

### B. Second Embodiment

<B-1. Configuration (Differences from First Embodiment)>

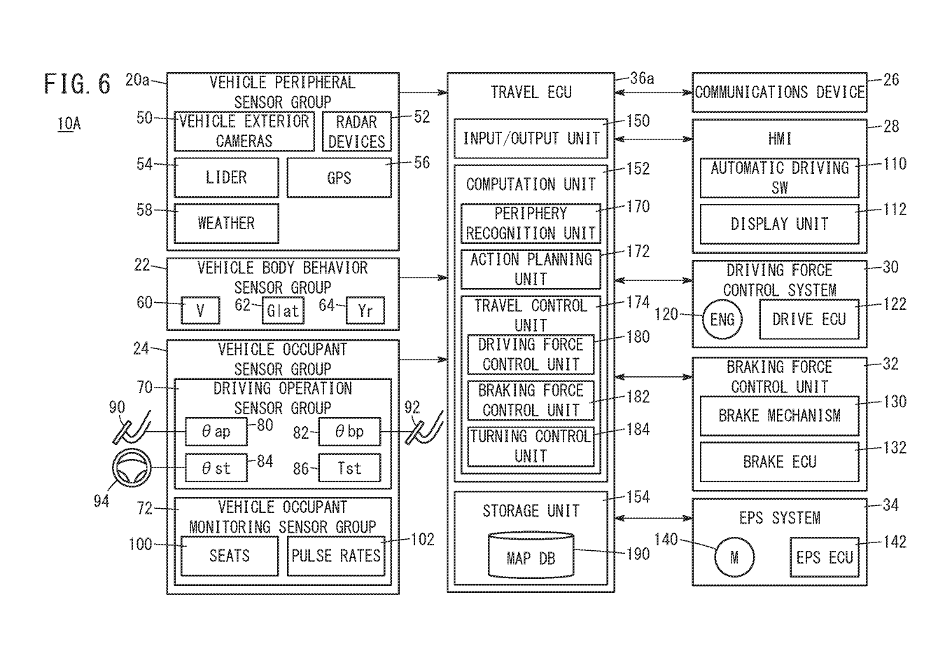

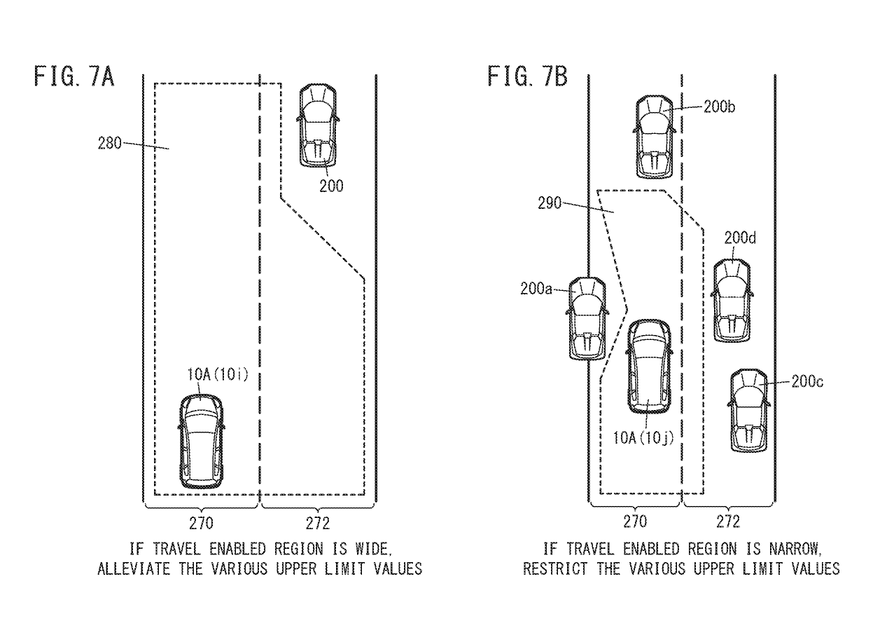

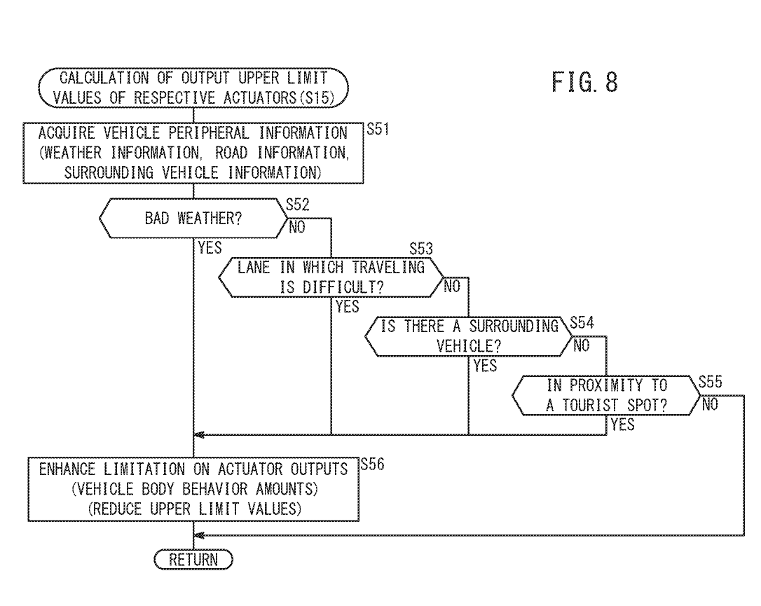

FIG. 6 is a block diagram showing the configuration of a vehicle 10A including a travel electronic control unit 36a (hereinafter referred to as a “travel ECU 36a” or “ECU 36a”) as a travel control device according to a second embodiment of the present invention. The ECU 36a of the second embodiment calculates the output upper limit values Pmax for the actuators using a method (FIGS. 7A to 8) that differs from that of the ECU 36 according to the first embodiment. The vehicle 10A of the second embodiment has the same configuration as that of the vehicle 10 of the first embodiment, with the exception of the following points. Below, the same reference numerals are provided in relation to the same constituent elements as those in the first embodiment, and detailed description of such features is omitted.

In the vehicle 10A according to the second embodiment, a weather sensor 58 is included in a vehicle peripheral sensor group 20a. The weather sensor 58 detects the weather conditions in the vicinity of the vehicle 10A, and outputs weather information Icli to the travel ECU 36a. Using the weather information Icli from the weather sensor 58, the travel ECU 36a calculates output upper limit values Pmax for each of the actuators. Further, the ECU 36 calculates the output upper limit values Pmax for each of the actuators using the road information Iroad stored in the map DB 190, and the surrounding vehicle information Iov based on the vehicle peripheral information Ic from the vehicle peripheral sensor group 20a. The surrounding vehicle information Iov is information concerning surrounding vehicles (other vehicles 200, etc., shown in FIG. 7A) that exist in the vicinity of the user's own vehicle 10A. Details of these features will be described later with reference to FIGS. 7A to 8.

### <B-2. Automatic Driving Control of the Second Embodiment>

[B-2-1. Outline of Automatic Driving Control of the Second Embodiment (Differences from the First Embodiment)]

The automatic driving control, which is executed by the ECU 36a of the second embodiment, is the same as the automatic driving control executed by the ECU 36 of the first embodiment. However, concerning the specific method of calculating the output upper limit values Pmax for the actuators (step S15 of FIG. 2), in the first embodiment, the method of FIGS. 3 to 5 was used, whereas in the second embodiment, the method of FIGS. 7A to 8 is used. However, the method of the first embodiment may be combined with the method of the second embodiment.

### [B-2-2. Calculation of Respective Output Upper Limit Values Pmax (Step S15 of FIG. 2)]

### (B-2-2-1. Basic Concept)

FIG. 7A is an explanatory diagram showing a case in which, in the second embodiment, only one other vehicle 200 is present in the vicinity of the user's own vehicle 10A. In FIG. 7A, the user's own vehicle 10A (hereinafter also referred to as a “user's own vehicle 10i”) is traveling in a travel lane 270. The other vehicle 200 is traveling in an adjacent lane 272. A travel enabled region 280 shown in FIG. 7A is calculated in step S16 of FIG. 2 with reference to the user's own vehicle 10i.

FIG. 7B is a diagram showing a state in which, in the second embodiment, four other vehicles 200a to 200d exist in the vicinity of the user's own vehicle 10A. In FIG. 7B, the user's own vehicle 10A (hereinafter also referred to as a “user's own vehicle 10j”) is traveling in the travel lane 270. The other vehicle 200a is parked at the end of the lane 270. The other vehicle 200b is traveling in the same lane 270 as the user's own vehicle 10j. The other vehicles 200c, 200d are traveling in the adjacent lane 272. A travel enabled region 290 shown in FIG. 7B is calculated in step S16 of FIG. 2 with reference to the user's own vehicle 10j.

As shown in FIG. 7A, in the case that there are a few other vehicles 200 acting as peripheral obstacles, the ECU 36a widens the travel enabled region calculated in step S16 of FIG. 2. In a situation in which a wide travel enabled region can be set, the ECU 36a alleviates the restriction on the output upper limit values Pmax of the actuators. Stated otherwise, the travel enabled region becomes widened by alleviating the limitation on the output upper limit values Pmax.

On the other hand, as shown in FIG. 7B, in the case that there are several other vehicles 200a to 200d acting as peripheral obstacles, the ECU 36a narrows the travel enabled region calculated in step S16 of FIG. 2. In a situation in which a wide travel enabled region cannot be set, the ECU 36a does not alleviate the restriction on the output upper limit values Pmax of the actuators. Stated otherwise, in the case that the limitation on the output upper limit values Pmax is not alleviated, the travel enabled region does not become widened.

As will be described later with reference to FIG. 8, the ECU 36a of the second embodiment changes the output upper limit values Pmax of the actuators using the vehicle peripheral information Ic (the weather information Icli, the road information Iroad, and the surrounding vehicle information Iov).

### (B-2-2-2. Specific Method of Calculating Output Upper Limit Values Pmax)

FIG. 8 is a flowchart (details of step S15 in FIG. 2) for calculating the output upper limit values Pmax of the respective actuators in the second embodiment. It is also possible for the output upper limit values Pmax to be calculated by combining the flowchart of FIG. 8 (second embodiment) with the flowchart of FIG. 5 (first embodiment).

In step S51 of FIG. 8, the travel ECU 36a acquires the vehicle peripheral information Ic. In the vehicle peripheral information Ic, there are included the weather information Icli, the road information Iroad, and the surrounding vehicle information Iov.

The weather information Icli is information concerning the weather conditions in the vicinity of the user's own vehicle 10A, and is acquired from the weather sensor 58. The road information Iroad is information concerning the shape of the road in the vicinity of the user's own vehicle 10A, and is acquired from the map DB 190. The surrounding vehicle information Iov is information concerning other vehicles (the other vehicle 200 in FIG. 7A, etc.) that exist in the vicinity of the user's own vehicle 10A, and is acquired from the vehicle peripheral sensor group 20a on the basis of the surrounding vehicle information Iov.

In step S52, based on the weather information Icli, the ECU 36a determines whether or not the area in the vicinity of the user's own vehicle 10A is experiencing bad weather conditions. The bad weather conditions referred to herein imply weather conditions which adversely affect traveling of the user's own vehicle 10A, and include, for example, rain and wind. If the area in the vicinity of the user's own vehicle 10A is experiencing bad weather conditions (step S52: YES), the process proceeds to step S56. If the area in the vicinity of the user's own vehicle 10A is not experiencing bad weather conditions (step S52: NO), the process proceeds to step S53.

In step S53, the ECU 36a determines whether or not traveling in the travel lane of the user's own vehicle 10A is difficult on the basis of the road information Iroad. The condition of “whether or not traveling is difficult” is determined, for example, on the basis of the following criteria in relation to attributes of the travel lane.

(1) Whether or not the width of the travel lane is narrower than a width threshold;

(2) Whether or not the travel lane is in a tunnel; and

(3) Whether or not the travel lane is a sharp curve (whether or not the radius of curvature of the travel lane is smaller than a radius of curvature threshold).

If it is difficult for the user's own vehicle 10A to travel in the travel lane (step S53: YES), the process proceeds to step S56. If it is not difficult for the user's own vehicle 10A to travel in the travel lane (step S53: NO), the process proceeds to step S54.

In step S54, the ECU 36a determines whether or not there is a surrounding vehicle (another vehicle 200, etc.) in the vicinity of the user's own vehicle 10A on the basis of the surrounding vehicle information Iov. If there is a surrounding vehicle (step S54: YES), the process proceeds to step S56. If there is not a surrounding vehicle (step S54: NO), the process proceeds to step S55.

In step S55, the ECU 36a determines whether or not the user's own vehicle 10A is traveling in proximity to a tourist spot on the basis of the road information Iroad. If traveling in proximity to a tourist spot (step S55: YES), the process proceeds to step S56. If not traveling in proximity to a tourist spot (step S55: NO), the current process is terminated, and after a predetermined time period has elapsed, the process returns to step S51.

In step S56, the ECU 36a enhances the limitation on the outputs (or the vehicle body behavior amounts Qb) of the actuators. More specifically, the ECU 36a decreases the output upper limit values Pmax.

Moreover, enhancement of the limitation in step S56 can be made variable in accordance with the vehicle peripheral information Ic. For example, the limitation may be changed depending on whether the content of bad weather conditions (step S52) is rain or wind. Further, the limitation may be changed according to the amount of precipitation amount or the air volume (wind speed). Further, the limitation can be made to change in accordance with the content (the lane width, inside a tunnel, etc.) of the traveling difficulty of the lane (step S53). Furthermore, the limitation may be changed depending on the number of surrounding vehicles, or the distance (or TTC, time-to-collision) of such vehicles with respect to the user's own vehicle 10A.

In steps S52 to S54 of FIG. 8, it can be said that the limitation on the actuator outputs (or vehicle behavior amounts) is enhanced in accordance with the traveling difficulty level, as indicated by the vehicle peripheral information Ic. More specifically, it can be said that the judgments made in steps S52 to S54 are determinations as to whether or not the traveling difficulty level, which is indicated by the vehicle peripheral information Ic, belongs to a relatively high classification. For example, in the case that the value thereof, such as the precipitation amount or the air volume (wind speed), indicates a certain traveling difficulty level, it is also possible to determine whether or not it is necessary to limit the actuator outputs (or vehicle behavior amounts) by comparing the traveling difficulty level with a difficulty level threshold value.

### <B-3. Advantages and Effects of the Second Embodiment>

According to the second embodiment as described above, the following effects can be obtained in addition to or instead of the effects of the first embodiment.

More specifically, according to the second embodiment, the travel ECU 36a (travel control device) acquires the vehicle peripheral information Ic, which is recognized by the vehicle peripheral sensor group 20a (periphery recognition devices) (step S51 of FIG. 8). In the case that the traveling difficulty level, which is indicated by the vehicle peripheral information Ic, belongs to a relatively high classification (step S52: YES, step S53: YES, or step S54: YES), the ECU 36a enhances the limitation on the actuator outputs (or the vehicle body behavior amounts Qb) (step S56). In accordance with this feature, the limitation on the actuator outputs (vehicle body behavior amounts Qb) accompanying the travel control is changed according to the traveling difficulty level. Therefore, a positive travel control fitting with the traveling difficulty level is made possible.

### C. Modifications

The present invention is not limited to the embodiments described above, and various modified or additional configurations could be adopted therein based on the content of the present specification. For example, the following configurations can be adopted.

<C-1. Objects to which Invention can be Applied>

In each of the embodiments described above, it was assumed that the travel ECU 36, 36a (travel control device) was used in a vehicle 10, 10A such as an automobile (or car) (see FIGS. 1 and 6). However, for example, from the standpoint of alleviating limitations on the vehicle body behavior amounts Qb during automatic driving according to a state of the vehicle occupants detected by the vehicle occupant sensors, the present invention is not limited in this manner. For example, the vehicle 10, 10A (or conveyance) may be a moving object such as a ship, an aircraft, or the like. Alternatively, concerning such vehicles 10, 10A, other devices can also be used (for example, various manufacturing devices, or robots).

### <C-2. Configuration of Vehicle 10>

### [C-2-1. Sensor Groups 20, 20a, 22, 24]

The vehicle peripheral sensor group 20 of the first embodiment includes the plurality of vehicle exterior cameras 50, the plurality of radar devices 52, the LIDAR system 54, and the GPS sensor 56 (see FIG. 1). However, for example, from the standpoint of detecting travel lanes (or lane markings) such as the travel lane 210 shown in FIG. 3, and peripheral objects (such as the other vehicle 200 shown in FIG. 3), the present invention is not limited to this feature. In the case that the plurality of vehicle exterior cameras 50 include a stereo camera adapted to detect a region in front of the vehicle 10, the radar devices 52 and/or the LIDAR system 54 can be omitted. These features also apply to the second embodiment.

The vehicle body behavior sensor group 22 according to the first embodiment includes the vehicle velocity sensor 60, the lateral acceleration sensor 62, and the yaw rate sensor 64 (see FIG. 1). However, for example, from the standpoint of alleviating limitations on the vehicle body behavior amounts Qb during automatic driving according to a state of the vehicle occupants detected by the vehicle occupant sensors, the present invention is not limited in this manner. For example, it is possible to eliminate one or more of the vehicle velocity sensor 60, the lateral acceleration sensor 62, or the yaw rate sensor 64.

The driving operation sensor group 70 according to the first embodiment includes the AP sensor 80, the BP sensor 82, the steering angle sensor 84, and the steering torque sensor 86 (see FIG. 1). However, for example, from the standpoint of alleviating limitations on the vehicle body behavior amounts Qb during automatic driving according to a state of the vehicle occupants detected by the vehicle occupant sensors, the present invention is not limited in this manner. For example, it is possible for one or more of the AP sensor 80, the BP sensor 82, the steering angle sensor 84, and the steering torque sensor 86 to be omitted. These features also apply to the second embodiment.

In the vehicle occupant monitoring sensor group 72, there are included the seat sensors 100 and the pulse rate sensors 102 (see FIG. 1). However, for example, from the standpoint of alleviating limitations on the vehicle body behavior amounts Qb during automatic driving according to a state of the vehicle occupants detected by the vehicle occupant sensors, the present invention is not limited in this manner. For example, it is possible for one of the seat sensors 100 and the pulse rate sensors 102 to be omitted.

Alternatively, another vehicle occupant sensor can be provided in addition to or instead of one or both of the seat sensors 100 and the pulse rate sensors 102. As such an occupant sensor, for example, a perspiration sensor or an electroencephalogram sensor can be used. For example, the perspiration sensor can be configured as a resistance sensor (a sensor that measures an impedance changed by sweat) provided in the steering wheel 94. In addition, the electroencephalogram sensor can be configured as a voltage sensor arranged on the occupant's head. These features also apply to the second embodiment.

### [C-2-2. Actuators]

According to the first embodiment, the engine 120, the brake mechanism 130, and the EPS motor 140 are used as actuators that serve as targets for the automatic driving control (see FIG. 1). However, for example, from the standpoint of alleviating limitations on the vehicle body behavior amounts Qb during automatic driving according to a state of the vehicle occupants detected by the vehicle occupant sensors, the present invention is not limited in this manner. For example, one or two of the engine 120, the brake mechanism 130, and the EPS motor 140 can be excluded from being targets of the automatic driving control. In the case that any one of the actuators is excluded from being the target of the automatic driving control, the driver carries out the control of that actuator that was removed from being the target. Furthermore, as described above, in place of the EPS motor 140, it is also possible to perform turning using a torque difference between the left and right wheels. These features also apply to the second embodiment.

### <C-3. Control by the Travel ECU 36>

According to the first embodiment, a description has been given concerning automatic driving that does not require driving operations of the driver for any one of acceleration, deceleration, and turning of the vehicle 10 (see FIG. 2). However, for example, from the standpoint of alleviating limitations on the vehicle body behavior amounts Qb during automatic driving according to a state of the vehicle occupants detected by the vehicle occupant sensors, the present invention is not limited in this manner. For example, the present invention can also be applied to automatic driving that does not require driving operations of the driver for only one or two of acceleration, deceleration, and turning of the vehicle 10, or to automatic driving in which driving operations of the driver are assisted. These features also apply to the second embodiment.

According to the first embodiment, the AP operation amount θap, the BP operation amount θbp, and the steering angle θst are compared with the operation amount lower limit values THmin and the operation amount upper limit values THmax (steps S35, S37, S40 of FIG. 5). However, for example, from the standpoint of alleviating limitations on the vehicle body behavior amounts Qb during automatic driving according to a state of the vehicle occupants detected by the vehicle occupant sensors, the present invention is not limited in this manner. For example, a comparison may be carried out of only one or two of the AP operation amount θap, the BP operation amount θbp, and the steering angle θst. Alternatively, a comparison can be carried out of driving operation amounts other than the AP operation amount θap, the BP operation amount θbp, and the steering angle θst. As one such driving operation amount, for example, a steering torque Tst can be used.

According to the second embodiment, the determinations of steps S52 to S55 of FIG. 8 are combined. However, if attention is focused on each of the steps S52 to S55 respectively, it is possible for one or more of these steps to be eliminated.

According to the second embodiment, the limitation on the actuator outputs (or the vehicle body behavior amounts Qb) is enhanced in accordance with the presence or absence of surrounding vehicles, as well as the number or distance (traveling state) of the surrounding vehicles (step S56 of FIG. 8). However, for example, from the standpoint of enhancing or alleviating the limitation on the outputs (or the vehicle body behavior amounts Qb) of the actuators in relation to the surrounding vehicles, the present invention is not limited to this feature. For example, the limitation on the actuator outputs (or the vehicle body behavior amounts Qb) may be enhanced or alleviated depending on the type of the surrounding vehicles (a passenger car, a bus, a truck, etc.). Alternatively, the limitation on the actuator outputs (or the vehicle body behavior amounts Qb) can be enhanced or alleviated on the basis of whether or not the user's own vehicle 10A is traveling in a traffic jam, or whether or not there is (a traveling state in which) a truck exists on the side of the user's own vehicle 10A.

According to the first embodiment, the limitation on the actuator outputs (or the vehicle body behavior amounts Qb) is reflected in the output upper limit values Pmax (step S15 in FIG. 2, FIG. 5). However, for example, from the standpoint of alleviating limitations on the vehicle body behavior amounts Qb during automatic driving according to a state of the vehicle occupants detected by the vehicle occupant sensors, the present invention is not limited in this manner. For example, it is also possible for the limitation on the vehicle body behavior amounts Qb, in accordance with the state of the vehicle occupants detected by the vehicle occupant sensors, to be reflected in the travel enabled area (step S16 in FIG. 2) or the target travel trajectory Ltar. These features also apply to the second embodiment.

### <C-4. Other Considerations>

In the above-described respective embodiments, cases exist in which an equal sign is included or not included in the numerical comparisons (steps S35, S37, S40, etc., of FIG. 5). However, for example, if there is no special reason for including or excluding such an equal sign (or stated otherwise, for cases in which the effects of the present invention are obtained), it can be set arbitrarily as to whether to include an equal sign in the numerical comparisons.

As to what this implies, for example, the determination (THmin≧operation amounts THmax) as to whether or not the operation amounts θap, θbp, θst in step S35 of FIG. 5 are greater than or equal to the operation amount lower limit value THmin and less than or equal to the operation amount upper limit value THmax can be changed to a determination (THmin<operation amounts<THmax) as to whether or not the operation amounts θap, θbp, θst are greater than the operation amount lower limit value THmin and less than the operation amount upper limit value THmax. In this case, a change is made in which it is determined to include equal signs in the comparisons of steps S37 and S40 (operation amount≦THmin and operation amount≧THmax).

### D. Description of Reference Characters

10, 10A . . . vehicle
36, 36a . . . ECU (travel control device)
50 . . . vehicle exterior cameras (periphery recognition devices)
52 . . . radar devices (periphery recognition devices)
54 . . . LIDAR system (periphery recognition device)
56 . . . GPS sensor (periphery recognition device)
80 . . . accelerator pedal sensor (vehicle occupant sensor)
82 . . . brake pedal sensor (vehicle occupant sensor)
84 . . . steering angle sensor (vehicle occupant sensor)
86 . . . steering torque sensor (vehicle occupant sensor)
100 . . . seat sensors (vehicle occupant sensors)
102 . . . pulse rate sensors (vehicle occupant sensors)
Glat . . . lateral acceleration (vehicle body behavior amount)
Qb . . . vehicle body behavior amounts
THmax . . . operation amount upper limit value (operation amount threshold value)
V . . . vehicle velocity (vehicle body behavior amount)
Yr . . . yaw rate (vehicle body behavior amount)
α . . . longitudinal acceleration (vehicle body behavior amount)
β . . . longitudinal deceleration (vehicle body behavior amount)
θap . . . AP operation amount
θbp . . . BP operation amount
θst . . . steering angle (operation amount)

What is claimed is:

1. A travel control device which is adapted to control automatic driving to assist driving operations of a driver, or to control automatic driving to enable traveling without requiring driving operations of the driver;
wherein the travel control device is configured to alleviate a limitation on a vehicle body behavior amount during the automatic driving, in accordance with a state of a vehicle occupant detected by a vehicle occupant sensor.

2. The travel control device according to claim 1, wherein:
an operation amount of turning, acceleration, or deceleration by the vehicle occupant is acquired as the state of the vehicle occupant; and
the limitation on the vehicle body behavior amount targeted by the operation amount is configured to be alleviated in accordance with an increase in the operation amount.

3. The travel control device according to claim 2, wherein if the operation amount exceeds an operation amount threshold value, an operation of the operation amount is configured to be switched to manual.

4. The travel control device according to claim 1, wherein the vehicle body behavior amount is configured to be limited if it is determined that the state of the vehicle occupant detected by the vehicle occupant sensor indicates that the vehicle occupant is in a tense or nervous state.

5. The travel control device according to claim 1, wherein the limitation on the vehicle body behavior amount is configured to be alleviated based on a seated position of the vehicle occupant, which is detected by a seat sensor contained within the vehicle occupant sensor.

6. The travel control device according to claim 5, wherein, in a case that the vehicle occupant is seated in a seat other than a driver's seat, an amount of alleviation of the limitation on the vehicle body behavior amount is configured to be reduced, or the limitation of the vehicle body behavior amount is configured to be enhanced.

7. The travel control device according to claim 6, wherein, in comparison with a case in which vehicle occupants are seated in both the driver's seat and the seat other than the driver's seat, in a case that the vehicle occupant is seated in the seat other than the driver's seat without a vehicle occupant being seated in the driver's seat, the amount of alleviation of the limitation is configured to be reduced, or the limitation of the vehicle body behavior amount is configured to be enhanced.

8. The travel control device according to claim 1, wherein:
peripheral information of the vehicle, which is recognized by a periphery recognition device, is configured to be acquired; and
in a case that a traveling difficulty level, which is indicated by the peripheral information, belongs to a relatively high classification, or in a case that the traveling difficulty level is higher than a difficulty level threshold value, the limitation on the vehicle body behavior amount is configured to be enhanced.

9. The travel control device according to claim 8, wherein the peripheral information includes information of at least one of the presence or absence of another vehicle in vicinity of the vehicle, a traveling state of the other vehicle, an attribute of a travel lane, and a weather condition in the vicinity of the vehicle.
